(19) United States
(12) Patent Application Publication
(10) Pub. No.: US 2011/0074302 A1
(43) Pub. Date: Mar. 31, 2011

(54) Phase Control Dimming Compatible Lighting Systems

(76) Inventors: William A. Draper, Austin, TX (US); Robert Grisamore, Austin, TX (US)

(21) Appl. No.: 12/570,550

(22) Filed: Sep. 30, 2009

(51) Int. Cl. H05B 41/36

(52) U.S. Cl. 315/224

(57) ABSTRACT

A power control/lighting system includes a controller to provide compatibility between a lamp ballast configured to receive a dedicated dimmer signal and a phase control dimmer. In at least one embodiment, the controller converts a phase control dimming signal into dimming information useable by a lamp ballast of a gas discharge lamp based lighting system. Additionally, in at least one embodiment, the controller also controls power factor correction of the power control/lighting system. In at least one embodiment, the controller provides dimming information based on the phase control dimming signal that allows the lamp ballast to be used in conjunction with a phase control dimmer.

### CROSS REFERENCE TO RELATED APPLICATIONS

U.S. patent application Ser. No. 11/967,269, entitled “Power Control System Using a Nonlinear Delta-Sigma Modulator with Nonlinear Power Conversion Process Modeling,” inventor John L. Melanson, Attorney Docket No. 1745-CA, and filed on Dec. 31, 2007 describes exemplary methods and systems and is incorporated by reference in its entirety. Referred to herein as Melanson I.

U.S. patent application Ser. No. 11/967,271, entitled “Power Factor Correction Controller with Feedback Reduction,” inventor John L. Melanson, Attorney Docket No. 1756-CA, and filed on Dec. 31, 2007 describes exemplary methods and systems and is incorporated by reference in its entirety. Referred to herein as Melanson II.

U.S. patent application Ser. No. 11/967,273, entitled “System and Method with Inductor Flyback Detection Using Switch Date Charge Characteristic Detection,” inventor John L. Melanson, Attorney Docket No. 1758-CA, and filed on Dec. 31, 2007 describes exemplary methods and systems and is incorporated by reference in its entirety. Referred to herein as Melanson III.

U.S. patent application Ser. No. 11/967,275, entitled “Programmable Power Control System,” inventor John L. Melanson, Attorney Docket No. 1759-CA, and filed on Dec. 31, 2007 describes exemplary methods and systems and is incorporated by reference in its entirety. Referred to herein as Melanson IV.

(5) U.S. patent application Ser. No. 11/967,272, entitled “Power Factor Correction Controller With Switch Node Feedback”, inventor John L. Melanson, Attorney Docket No. 1757-CA, and filed on Dec. 31, 2007 describes exemplary methods and systems and is incorporated by reference in its entirety. Referred to herein as Melanson V.

U.S. patent application Ser. No. 12/347,138, entitled “Switching Power Converter Control With Triac-Based Leading Edge Dimmer Compatibility”, inventors Michael A. Cost, Mauro L. Gaetano, and John L. Melanson, Attorney Docket No. 1798-IPD, and filed on Dec. 31, 2008 describes exemplary methods and systems and is incorporated by reference in its entirety. Referred to herein as Melanson VI.

### BACKGROUND OF THE INVENTION

1. Field of the Invention

The present invention relates in general to the field of electronics, and more specifically to a system and method for providing compatibility between phase controlled dimmers and lighting systems.

2. Description of the Related Art

Dimming a light source saves energy and also allows a user to adjust the intensity of the light source to a desired level. Many facilities, such as homes and buildings, include light source dimming circuits (referred to herein as “dimmers”). Power control systems with switching power converters are used to control light sources, such as discharge-type lamps. Discharge lamps include gas discharge lamps such as, fluorescent lamps, and high intensity discharge lamps, such as mercury vapor lamps, metal halide (MH) lamps, ceramic MH lamps, sodium vapor lamps, and Xenon short-arc lamps. However, conventional phase control dimmers, such as a triac-based dimmer, that are designed for use with resistive loads, such as incandescent light bulbs, often do not perform well when supplying a raw, phase modulated signal to a reactive load, such as a switching power converter. Ballasts for many discharge lamps are not compatible with phase control dimmers. Many discharge lighting systems receive dimming information from a dimmer that provides a dedicated dimming signal. The dedicated dimming signal provides dimming information that is separate from power signals.

FIG. 1 depicts a power/lighting system 100 that receives dimming information via a dedicated dimming signal and, thus, avoids the problems of receiving dimming information via a phase-control dimmer Dimmer 102 provides lamp ballast 104 with a dedicated dimming signal in the form of dimming voltage signal D_{V}. Dimmer 102 provides a reliable dimming signal D_{V}. Dimmer 102 passes the AC input voltage V_{IN} from AC voltage source 106 to lamp ballast 104. Input voltage V_{IN} is, for example, a 60 Hz/110 V line voltage in the United States of America or a 50 Hz/220 V line voltage in Europe. Lamp ballast 104 provides a lamp voltage V_{LAMP} to drive discharge lamp 108. The value of the lamp voltage V_{LAMP} depends on the value of dimming voltage signal D_{V}.

FIG. 2 depicts a light output graph 400 representing a graphical dimming-intensity function 202 between values of the dimming voltage D_{V} and the percentage light intensity level of discharge lamp 108. The dimming voltage D_{V} ranges from 0-10V, and the light intensity level percentage of discharge lamp 108 ranges from 10-100%. The dimming-intensity function 202 indicates that lamp ballast 104 saturates when the dimming voltage D_{V} equals 1V and 9V. Between dimming voltage D_{V} values of 0-1V, lamp ballast 104 drives the discharge lamp 106 to 10% intensity. Between dimming voltage D_{V} values of 9-10V, lamp ballast 104 drives the discharge lamp 106 to 100% intensity, i.e. full “ON”. The dimming-intensity function 202 is linear between dimming voltage D_{V} values of 1-9V with intensity of lamp 106 varying from 10-100%.

Phase control dimmers are ubiquitous but do not work well with reactive loads, such as lamp ballast 104. Thus, lamp ballast 104 does not interface with existing phase control dimmer installations. Thus, for lighting systems having an existing phase control dimmer, the phase control dimmer is replaced or bypassed to facilitate use of dimmer 102. Replacing or bypassing phase controlled dimmer adds additional cost to the installation of dimmer 102. Additionally, lamp ballast 104 does not provide a full-range of dimming for lamp 106.

### SUMMARY OF THE INVENTION

In one embodiment of the present invention, an apparatus includes a controller having an input to receive a phase control dimming signal. The controller is configured to: (i) convert the phase control dimming signal into dimming information and (ii) generate a power factor correction (PFC) control signal for a switching power converter. The controller further includes a first output to provide the dimming information and a second output to provide the PFC control signal.

In another embodiment of the present invention, a method includes receiving a phase control dimming signal and converting the phase control dimming signal into dimming information for a lighting system. The method also includes generating a power factor correction (PFC) control signal for a switching power converter.

In a further embodiment of the present invention, a power control/lighting system includes a switching power converter having at least one input to receive a phase control dimming signal. The power control/lighting system also includes a controller having an input to receive the phase control dimming signal. The controller is configured to: (i) convert the phase control dimming signal into dimming information and (ii) generate a power factor correction (PFC) control signal for a switching power converter. The controller further includes a first output to provide the dimming information and a second output coupled to the switching power converter to provide the PFC control signal. The power control/lighting system also includes a lamp ballast coupled to the switching power converter and the second output of the controller and further includes a discharge-type lamp coupled to the lamp ballast.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 (labeled prior art) depicts a power/lighting system that receives dimming information via a dedicated dimming signal.

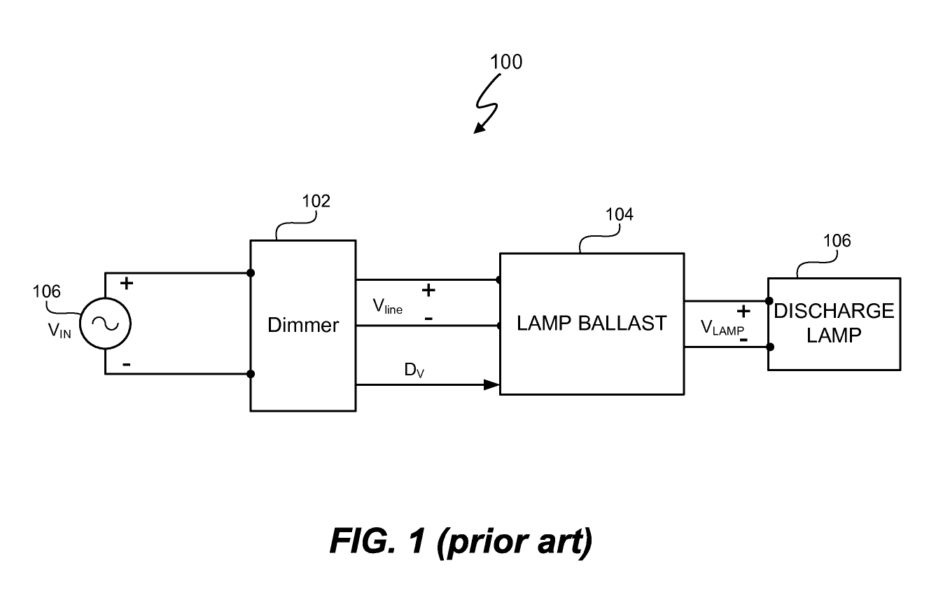

FIG. 2 depicts a light output graph representing a linear function between dimming voltage values and percentage light intensity levels in the power control/lighting system of FIG. 1.

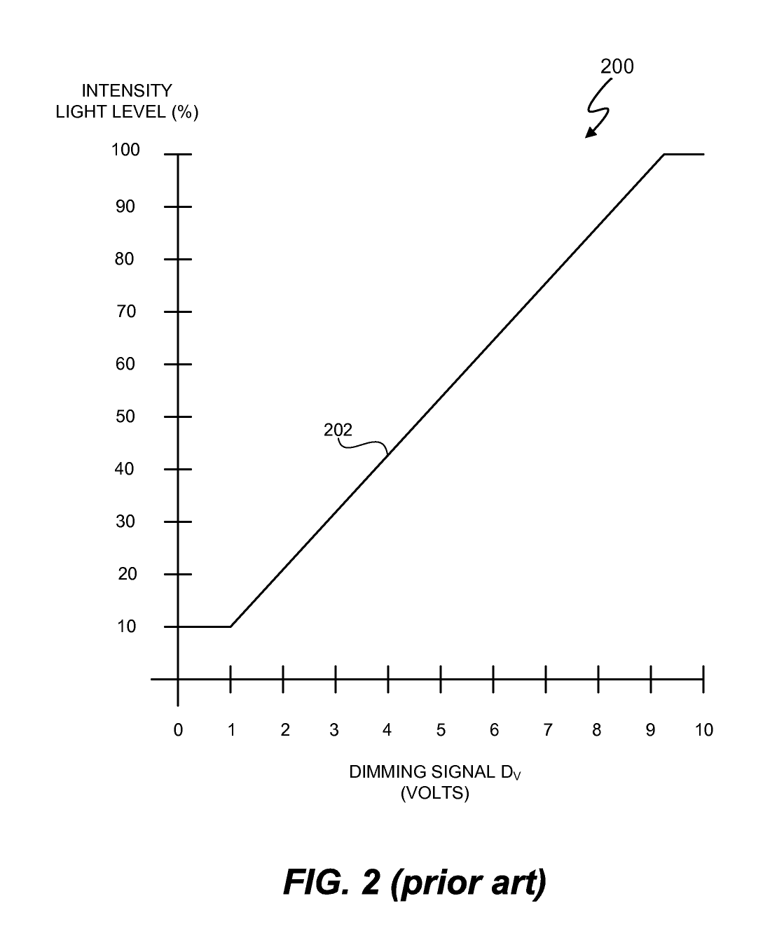

FIG. 3 depicts a power control/lighting system that includes a controller to convert a phase control dimming signal into dimming information.

FIG. 4 (labeled prior art) depicts exemplary voltage signals of the power control/lighting system of FIG. 3.

FIG. 5 depicts an embodiment of the power control/lighting system of FIG. 3.

FIG. 6 depicts one embodiment of a converter that converts a phase modulated, rectified phase control input voltage into dimming information.

FIG. 7 depicts another embodiment of a converter that converts a phase modulated, rectified phase control input voltage into dimming information using a lighting output function.

FIG. 8 depicts a graphical depiction of an exemplary lighting output function of FIG. 7.

FIG. 9 depicts another graphical depiction of an exemplary lighting output function of FIG. 7.

### DETAILED DESCRIPTION

A power control/lighting system includes a controller to provide compatibility between a lamp ballast configured to receive a dedicated dimmer signal and a phase control dimmer. In at least one embodiment, the controller converts a phase control dimming signal into dimming information useable by a lamp ballast of a gas discharge lamp based lighting system. Additionally, in at least one embodiment, the controller also controls power factor correction of the power control/lighting system. In at least one embodiment, the controller provides dimming information based on the phase control dimming signal that allows the lamp ballast to be used in conjunction with a phase control dimmer. In at least one embodiment, the controller also enables a switching power converter to provide a sufficiently high resistive load during phase delays of the phase control dimmer to, for example, prevent ripple and missed chopping of a phase dimmer output signal. In at least one embodiment, the controller can be configured to convert the phase control dimming signal into any format, protocol, or signal type so that the dimming information is compatible with input specifications of lamp ballast.

Light intensity level refers to the brightness of light from a lamp. In at least one embodiment, the light intensity level is represented as a percentage of a lamps' full brightness with 100% representing full brightness. In at least one embodiment, the controller is not limited to a linear light intensity level conversion between a light intensity level represented by a conduction angle of the phase control dimming signal and the light intensity level represented by the resultant dimming information. In at least one embodiment, to facilitate non-linear mapping, the controller maps light intensity levels represented by the phase control dimming signal to dimming information using a mapping function. Utilizing a mapping function that is not limited to a linear light intensity level conversion of the light intensity level represented by the phase control dimming signal to the dimming information provides flexibility to provide custom control of the light intensity level of a lamp.

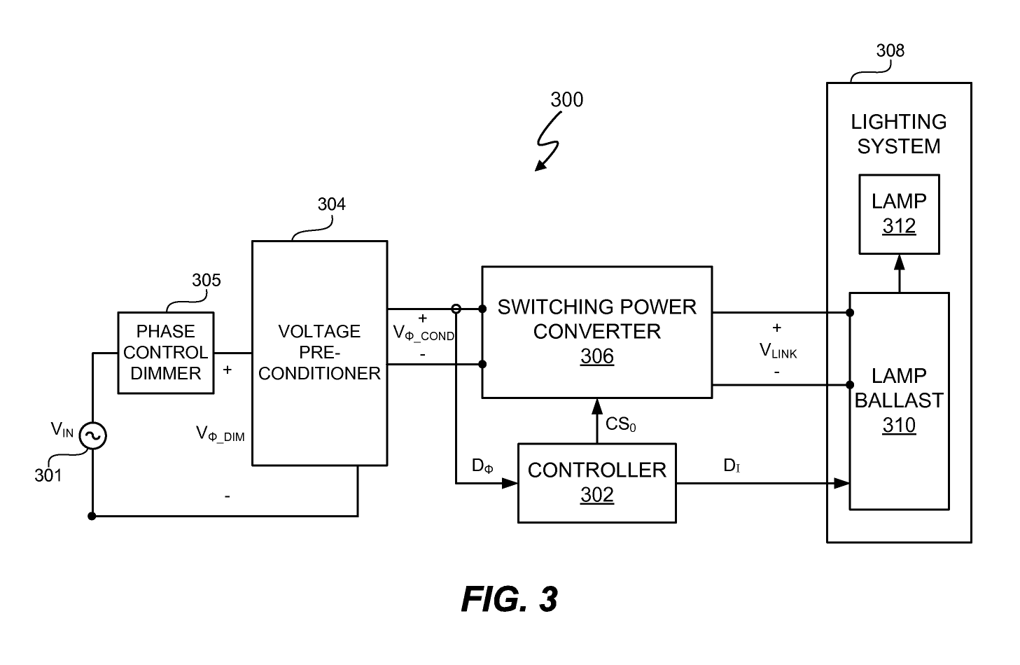

FIG. 3 depicts an exemplary power control/lighting system 300 that includes a controller 302 to convert a phase control dimming signal V_{Φ}_{_{—}}_{DIM} into dimming information D_{I}. Lamp ballast 310 is configured to receive a dimmer signal with dimmer information D_{I}, and controller 302 provides compatibility between phase control dimmer 305 and lamp ballast 310. Thus, among other functions, in at least one embodiment, controller 302 provides an interface between phase control dimmer 305 and lighting system 308 so that lighting system 308 can be dimmed using dimming information derived from phase control dimmer 305. The particular type of phase control dimmer 305 is a matter of design choice. In at least one embodiment, phase control dimmer 305 is a bidirectional triode thyristor (triac)-based circuit. Melanson VI describes an exemplary triac-based phase control dimmer. In at least one embodiment, phase control dimmer 305 is a transistor based dimmer, such as an insulated gate bipolar transistor (IGBT) based phase control dimmer, such as IGBT based phase control dimmers available from Strand Lighting, Inc., of Cypress, Calif., USA.

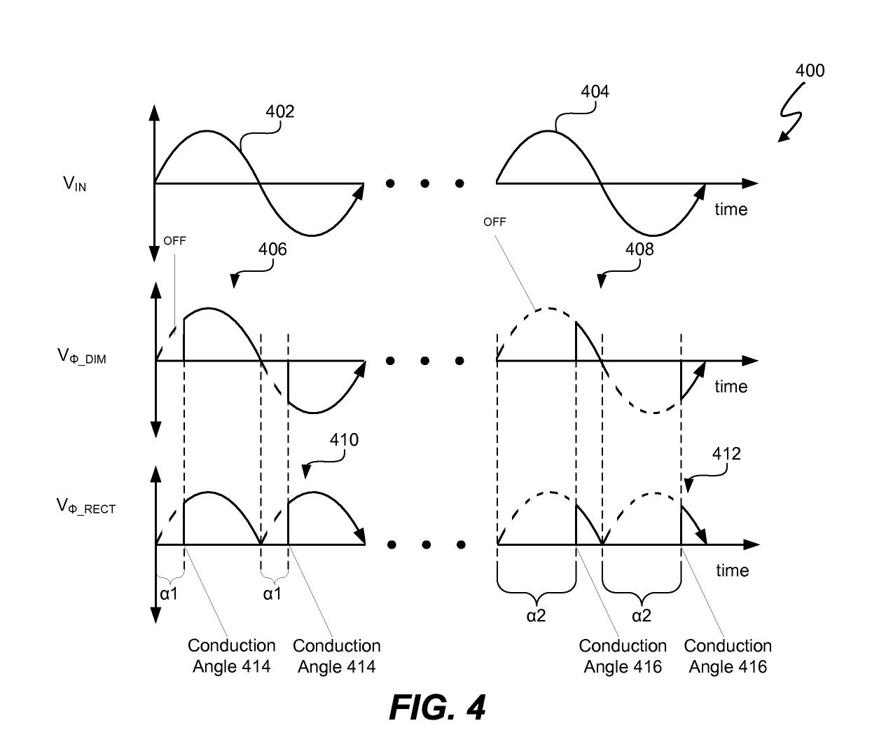

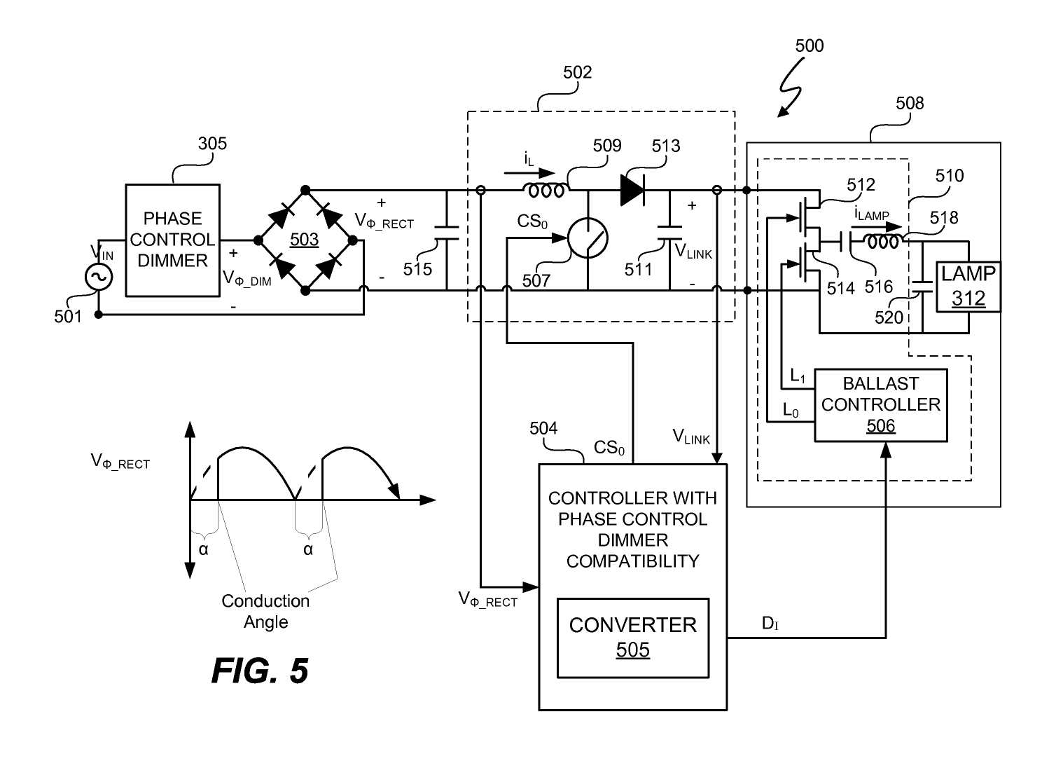

As explained in more detail with reference to FIG. 4, phase control dimmer 305 introduces phase delays with corresponding conduction angles in the input voltage V_{IN} from AC voltage source 301. Input voltage V_{IN} is, for example, a 60 Hz/110 V line voltage in the United States of America or a 50 Hz/220 V line voltage in Europe. Voltage preconditioner 304 receives the resultant phase control voltage V_{Φ}_{_{—}}_{DIM} from phase control dimmer 305 and generates a conditioned phase control voltage V_{Φ}_{_{—}}_{COND} for input to switching power converter 306. In at least one embodiment, voltage pre-conditioner 304 includes a rectifier, such as diode rectifier 503 (FIG. 5) and an EMI filter, such as capacitor 515. Thus, in at least one embodiment, phase control voltage V_{Φ}_{_{—}}_{COND} is a rectified sine wave with attenuated high frequency components. Switching power converter 306 converts the phase control voltage V_{Φ}_{_{—}}_{COND} into an approximately constant link voltage V_{LINK}.

FIG. 4 depicts a series of voltage waveforms 400 that represent two respective exemplary cycles of waveforms of input voltage V_{IN}, phase control voltage V_{Φ}_{_{—}}_{DIM}, and rectified phase control input voltage V_{Φ}_{_{—}}_{RECT}. Referring to FIGS. 3 and 4, during a dimming period, phase control dimmer 305 phase modulates the supply voltage V_{IN} by introducing phase delays a into the beginning of each half cycle of phase control voltage V_{Φ}_{_{—}}_{DIM}. “α” represents an elapsed time between the beginning and leading edge of each half cycle of phase control voltage V_{Φ}_{_{—}}_{DIM}. (“Introducing phase delays” is also referred to as “chopping”). The portion of the phase control voltage V_{Φ}_{_{—}}_{DIM} having a phase delay α is referred to as the “dimming portion”. For example, the phase delayed portions of voltages V_{Φ}_{_{—}}_{DIM} and V_{Φ}_{_{—}}_{RECT} represented by α1 and α2 are referred to as the “dimming portion” of voltages V_{Φ}_{_{—}}_{DIM} and V_{Φ}_{_{—}}_{RECT}. A “conduction angle” of the phase control voltage V_{Φ}_{_{—}}_{DIM} is the angle at which the phase delay a ends. The particular conduction angle of phase control voltage V_{Φ}_{_{—}}_{DIM} can be set by manually or automatically operating phase control dimmer 305.

The phase delay α and conduction angle are inversely related, i.e. as the phase delay α increases, the conduction angle decreases, and vice versa. When the phase delay α is zero, the conduction angle is 180 degrees for a half cycle of phase control voltage V_{Φ}_{_{—}}_{DIM}, and phase control dimmer 305 simply passes the supply voltage V_{IN} to full bridge diode rectifier 503. A conduction angle of 180 degrees for a half cycle of phase control voltage V_{Φ}_{_{—}}_{DIM} is the equivalent of a conduction angle of 360 degrees for a full cycle of phase control voltage V_{Φ}_{_{—}}_{DIM}. As subsequently described in more detail, the amount of phase delay α and the corresponding conduction angle depend upon the amount of selected dimming.

In at least one embodiment, supply voltage V_{IN} is a sine wave, as depicted, with two exemplary cycles 402 and 404. Phase control dimmer 305 generates the phase modulated voltage V_{Φ}_{_{—}}_{DIM} by chopping each half cycle of supply voltage V_{IN} to generate one, leading edge phase delay al for each respective half cycle of cycles 406 and 408 (V_{Φ}_{_{—}}_{DIM}) and 410 and 412 (V_{Φ}_{_{—}}_{RECT}). As the phase delay α increases, less power is delivered to lamp 312. Thus, changes in the phase angle α are inversely proportional to both the conduction angle and the intensity of lamp 312. For example, when the phase delay α increases, the light intensity level increases and the conduction angle of lamp 312 decreases. Phase delay al is shorter than phase delay α2 (and, thus, conduction angle 414 is greater than conduction angle 416), so cycle 408 represents a decrease in light intensity level relative to cycle 406.

Referring to FIG. 3, controller 302 includes an input to receive phase control signal D_{Φ}. Phase control signal D_{Φ} represents the phase control voltage V_{Φ}_{_{—}}_{COND}. In at least one embodiment, phase control signal D_{Φ} is the phase control voltage V_{Φ}_{_{—}}_{COND}. In at least one embodiment, phase control signal D_{Φ} is a scaled version of phase control voltage V_{Φ}_{_{—}}_{COND}. Phase control signal D_{Φ} has a conduction angle representing a light intensity level. Controller 302 converts phase control signal D_{Φ} into dimming information D_{I}. In at least one embodiment, dimming information D_{I} is a dedicated signal that specifies the light intensity level for lamp 312.

Lighting system 308 includes a lamp ballast 310, and lamp ballast 310 receives a link voltage V_{LINK} and dimming information D_{I}. The link voltage V_{LINK} is a power factor corrected, regulated voltage supplied by switching power converter 306. In at least one embodiment, lamp 312 is a discharge lamp such as a fluorescent lamp or a high intensity discharge lamp. Lamp ballast 310 can be any type of lamp ballast that controls the light intensity of lamp 312 in accordance with a light intensity level indicated by dimming information D_{I}. In at least one embodiment, lamp ballast 310 is a lamp ballast PN:B254PUNV-D available from Universal Lighting Technologies having an office in Nashville, Tenn., USA. In at least one embodiment, lamp ballast 310 includes an integrated circuit (IC) processor to decode dimming information D_{I} and control power provided to lamp 312 so that lamp 312 illuminates to a light intensity level indicated by dimming information D_{I}.

Controller 302 converts the phase control dimming signal D_{Φ} into any format, protocol, or signal type so that the dimming information D_{I} is compatible with input specifications of lamp ballast 310. Thus, the dimming information can be an analog or digital signal and conform to any signal-type, format, or protocol such as a pulse width modulated signal, a linear voltage signal, a nonlinear voltage signal, a digital addressable lighting interface (DALI) protocol signal, and an inter-integrated circuit (I²C) protocol signal. For example, in one embodiment, controller 302 converts the phase control dimming signal D_{Φ} into dimming information D_{I} represented by a voltage signal ranging from 0-10V In one embodiment, controller 302 generates the dimming information D_{I} as a pulse width modulated signal representing values 0-126, thus providing 127 light intensity levels.

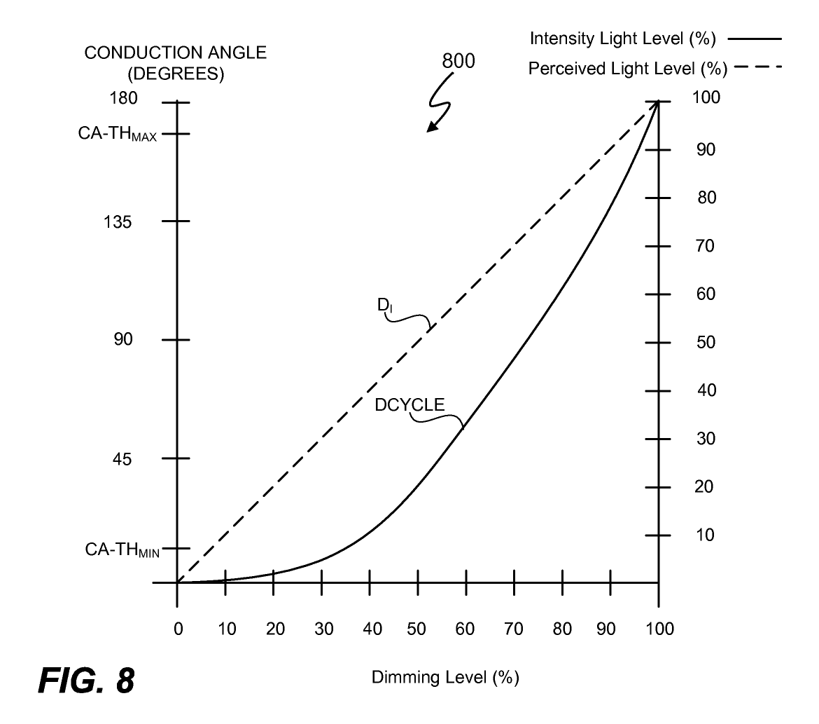

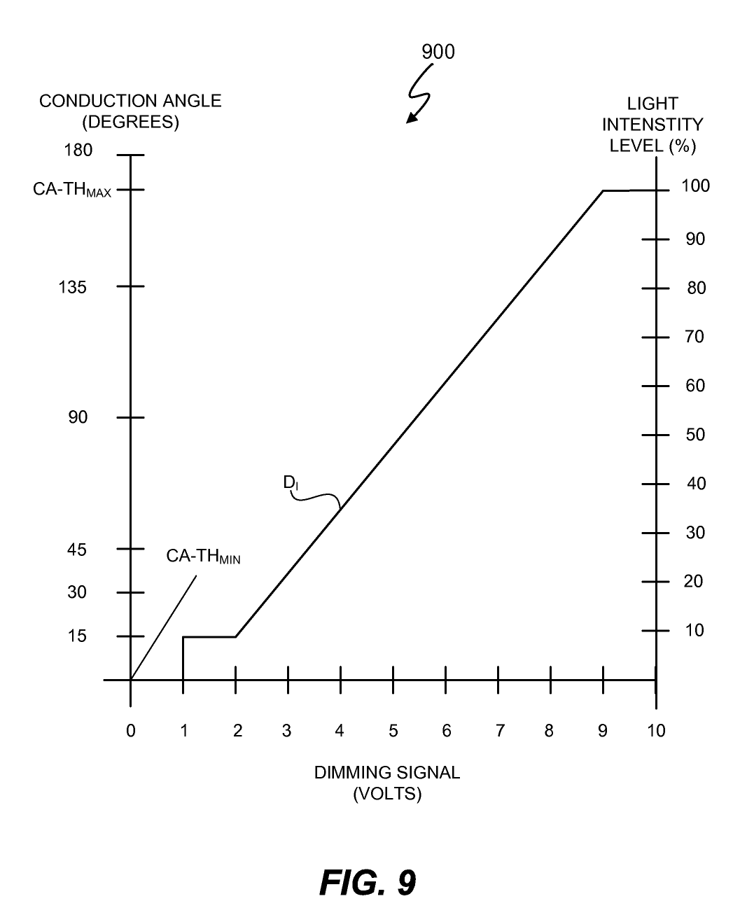

As subsequently described in more detail, in at least one embodiment, controller 302 is not limited to linearly converting a light intensity level represented by a conduction angle of the phase control dimming signal D_{Φ} and the light intensity level represented by the generated dimming information D_{I}. Thus, in at least one embodiment, controller 302 is not constrained to a one-to-one intensity level correlation between phase control dimming signal D_{Φ} and dimming information D_{I}. For example, in one embodiment of a non-linear conversion, a 180° degree conduction angle represents 100% intensity, and a 90° conduction angle represents an approximately 70% light intensity level. In at least one embodiment, controller 302 maps light intensity levels represented by the phase control dimming signal D_{Φ} to dimming information D_{I} using a non-linear mapping function. An exemplary non-linear mapping function is described in more detail with reference to FIGS. 8 and 9. A non-linear conversion of the light intensity level represented by the phase control dimming signal D_{Φ} to the dimming information D_{I} provides flexibility to provide custom control of the light intensity level of lamp 512. For example, in at least one embodiment and as subsequently described in more detail, controller 302 utilizes a mapping function to nonlinearly convert the phase control dimming signal D_{Φ} into dimming information D_{I} based on human perceived light intensity levels rather than light intensity levels based on power levels. Additionally, different mapping functions can be preprogrammed for selection that depends upon, for example, the particular operating environment and/or location of lamp 312.

In at least one embodiment, controller 302 also generates a switch control signal CS₀ to control power factor correction for switching power converter 306 and regulate link voltage V_{LINK}. Switching power converter 306 can be any type of switching power converter such as a boost, buck, boost-buck converter, or a Cúk converter. In at least one embodiment, switching power converter 306 is identical to switching power converter 102. Control of power factor correction and the link voltage V_{LINK} of switching power converter 306 is, for example, described in the exemplary embodiments of Melanson I, II, III, IV, and V.

FIG. 5 depicts power control/lighting system 500, which is one embodiment of power control/lighting system 300. As subsequently described in more detail, controller 504 represents one embodiment of controller 302. Controller 504 includes a converter 505 that converts rectified phase control input voltage V_{Φ}_{_{—}}_{RECT} into dimming information D_{I} to provide compatibility between phase control dimmer 305 and lamp ballast 310. Controller 504 also controls power factor correction for switching power converter 502. Switching power converter 502 represents one embodiment of switching power converter 306 and is a boost-type switching power converter. Voltage supply 501 provides an input voltage V_{IN} as an input voltage for power control/lighting system 500. Input voltage V_{IN} is, for example, a 60 Hz/110 V line voltage in the United States of America or a 50 Hz/220 V line voltage in Europe. Phase control dimmer 305 receives the supply voltage V_{IN} and generates a phase control voltage V_{Φ}_{_{—}}_{DIM} such as the phase control voltage V_{Φ}_{_{—}}_{DIM} of FIG. 4. Full bridge, diode rectifier 503 rectifies phase control voltage V_{Φ}_{_{—}}_{DIM} to generate the rectified phase control input voltage V_{Φ}_{_{—}}_{RECT} to the switching power converter 502. Filter capacitor 515 provides, for example, high frequency filtering of the rectified input voltage V_{Φ}_{_{—}}_{RECT}. Switching power converter 502 converts the input voltage V_{Φ}_{_{—}}_{RECT} into a regulated output voltage V_{LINK}, which provides an approximately constant supply voltage to lighting system 504. Lighting system 504 represents one embodiment of lighting system 308.

Switching power converter 502 varies an average current i_{L} in accordance with the conduction angle of rectified phase control input voltage V_{Φ}_{_{—}}_{RECT} so that the average power supplied by switching power converter 502 tracks the conduction angle of rectified phase control input voltage V_{Φ}_{_{—}}_{RECT}. Controller 504 controls switching power converter 502 by providing power factor correction and regulating output voltage V_{LINK}. The controller 504 controls an ON (i.e. conductive) and OFF (i.e. nonconductive) state of switch 507 by varying a state of pulse width modulated control signal CS₀. In at least one embodiment, the values of the pulse width and duty cycle of control signal CSₒ depend on sensing two signals, namely, the rectified phase control input voltage V_{Φ}_{_{—}}_{RECT} and the capacitor voltage/output voltage V_{LINK}.

Switching between states of switch 507 regulates the transfer of energy from the rectified line input voltage V_{Φ}_{_{—}}_{RECT} through inductor 509 to capacitor 511. The inductor current i_{L} ramps ‘up’ when the switch 507 is ON. The inductor current i_{L} ramps down when switch 507 is OFF and supplies current i_{L} to recharge capacitor 511. The time period during which inductor current i_{L} ramps down is commonly referred to as the “inductor flyback time”. During the inductor flyback time, diode 513 is forward biased. Diode 513 prevents reverse current flow into inductor 509 when switch 507 is OFF. In at least one embodiment, the switching power converter 502 operates in discontinuous current mode, i.e. the inductor current i_{L} ramp up time plus the inductor flyback time is less than the period of the control signal CS₀. When operating in continuous conduction mode, the inductor current i_{L} ramp-up time plus the inductor flyback time equals the period of control signal CS₀.

The switch 507 is a field effect transistor (FET), such as an n-channel FET. Control signal CS₀ is a gate voltage of switch 507, and switch 507 conducts when the pulse width of CS₀ is high. Thus, the ‘ON time’ of switch 507 is determined by the pulse width of control signal CS₀.

Capacitor 511 supplies stored energy to lighting system 508. The capacitor 511 is sufficiently large so as to maintain a substantially constant output voltage V_{LINK}, as established by controller 504. As load conditions change, the output voltage V_{LINK} changes. The controller 504 responds to the changes in output voltage V_{LINK} and adjusts the control signal CS₀ to restore a substantially constant output voltage V_{LINK} as quickly as possible. Power control/lighting system 100 includes a small, filter capacitor 515 in parallel with switching power converter 502. Capacitor 515 reduces electromagnetic interference (EMI) by filtering high frequency signals from the input voltage V_{Φ}_{_{—}}_{RECT}.

The goal of power factor correction technology is to make the switching power converter 502 appear resistive to the voltage source 501. Thus, controller 504 attempts to control the inductor current i_{L} so that the average inductor current i_{L} is linearly and directly related to the line input voltage V_{Φ}_{_{—}}_{RECT}. Control of power factor correction and the link voltage V_{LINK} of switching power converter 502 is, for example, described in the exemplary embodiments of Melanson I, II, III, IV, and V.

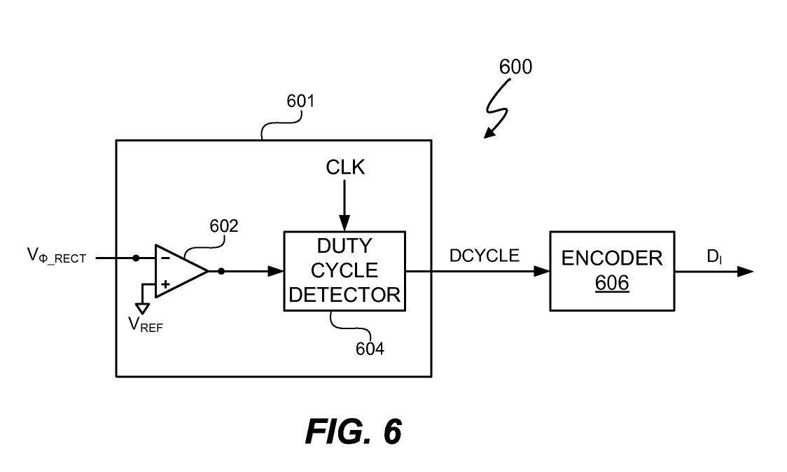

Converter 505 converts the rectified input voltage V_{Φ}_{_{—}}_{RECT} into dimming information D_{I}. The manner of converting rectified phase control input voltage V_{Φ}_{_{—}}_{RECT} into dimming information D_{I} is a matter of design choice. FIG. 6 depicts one embodiment of a converter 600 that converts rectified phase control input voltage V_{Φ}_{_{—}}_{RECT} into dimming information D_{I}. FIG. 6 depicts a converter 600 that converts rectified phase control input voltage V_{Φ}_{_{—}}_{RECT} into dimmer information D_{I}. Converter 600 represents one embodiment of converter 505. Converter 600 determines the duty cycle of dimmer output signal V_{DIM} by counting the number of cycles of clock signal f_{clk} that occur until the chopping point of dimmer output signal V_{DIM} is detected by the duty cycle time converter 600. The “chopping point” refers to the end of phase delay α (FIG. 5) of rectified phase control input voltage V_{Φ}_{_{—}}_{RECT}. The digital data DCYCLE represents the duty cycles of rectified phase control input voltage V_{Φ}_{_{—}}_{RECT}.

Converter 600 includes a phase detector 601 that detects a phase delay of rectified phase control input voltage V_{Φ}_{_{—}}_{RECT}. Comparator 602 compares rectified phase control input voltage V_{Φ}_{_{—}}_{RECT} against a known reference voltage V_{REF}. The reference voltage V_{REF} is generally the cycle cross-over point voltage of dimmer output voltage V_{DIM}, such as a neutral potential of a household AC voltage. The duty cycle detector 604 counts the number of cycles of clock signal CLK that occur until the comparator 602 detects that the chopping point of rectified phase control input voltage V_{Φ}_{_{—}}_{RECT} has been reached. Since the frequency of rectified phase control input voltage V_{Φ}_{_{—}}_{RECT} and the frequency of clock signal f_{clk} is known, in at least one embodiment, duty cycle detector 604 determines the duty cycle of rectified phase control input voltage V_{Φ}_{_{—}}_{RECT} in accordance with exemplary Equation [1] from the count of cycles of clock signal f_{clk} that occur until comparator 602 detects the chopping point of dimmer output signal V_{DIM}:

$$DCYCLE = \frac{1}{{f}_{V Φ\_ RECT}} - ( CNT \cdot \frac{1}{{f}_{clk}} ) , \qquad [ 1 ]$$

where 1/f_{VΦ}_{_{—}}_{RECT} represents the period of rectified phase control input voltage V_{Φ}_{_{—}}_{RECT}, CNT represents the number of cycles of clock signal f_{clk} that occur until the comparator 602 detects that the chopping point of rectified phase control input voltage V_{Φ}_{_{—}}_{RECT} has been reached, and 1/f_{clk} represents the period of the clock signal CLK.

Encoder 606 encodes digital duty cycle signal DCYCLE into dimming information D_{I}. The particular configuration of encoder 606 is a matter of design choice and depends on, for example, the signal type and protocol for which lamp ballast 310 is designed to receive. In at least one embodiment, encoder 606 is a digital-to-analog converter that encodes digital duty cycle signal DCYCLE as an analog voltage ranging from 0-10V. In at least one embodiment, encoder 606 is a pulse width modulator that encodes digital duty cycle signal DCYCLE as a pulse width modulated signal D_{I} having a pulse value ranging from 0-127. In other embodiments, encoder 606 is configured to encode digital duty cycle signal DCYCLE as a DALI signal D_{I} or an I²C signal D_{I}. Converter 600 can be implemented in software as instructions executed by a processor (not shown) of controller 604, as hardware, or as a combination of hardware and software.

Referring to FIG. 5, lighting system 508, which represents one embodiment of lighting system 308 (FIG. 3), includes ballast 510, and ballast 510 represents one embodiment of ballast 310 (FIG. 3). Controller 504 provides the dimming information D_{I} to ballast controller 506 of ballast 510. In at least one embodiment, ballast controller 506 is a conventional integrated circuit that receives dimming information D_{I} and generates lamp control signals L₀ and L₁. Lamp control signal L₀ controls conductivity of n-channel field effect transistor (FET) 512, and lamp control signal L₁ controls conductivity of n-channel FET 514. Ballast controller 506 controls the frequency of lamp control signals L₀ and L₁ to regulate current i_{LAMP} of capacitor 516 and inductor 518 to an approximately constant value. Capacitor 516 and inductor 518 conduct lamp current i_{LAMP}.

The dimming information D_{I} represents a light intensity level for lamp 312. As previously discussed, in at least one embodiment, the dimming information D_{I} represents a light intensity level derived from a conduction angle of the rectified input voltage V_{Φ}_{_{—}}_{RECT} as determined by controller 504. In at least one embodiment, to increase the intensity of lamp 312, ballast controller increases a duty cycle of lamp control signal L₀ and decreases a duty cycle of lamp control signal L₁. Conversely, to decrease the intensity of lamp 312, ballast controller 506 decreases a duty cycle of lamp control signal L₀ and increases a duty cycle of lamp control signal L₁. (“Duty cycle” refers to a ratio pulse duration to a period of a signal.) Capacitor 520 provides high frequency filtering. The component values of power control/lighting system 500 are a matter of design choice and depend, for example, on the desired link voltage V_{LINK} and power requirements of lighting system 508.

Controller 504 also utilizes sampled versions of the rectified input voltage V_{Φ}_{_{—}}_{RECT} and the link voltage V_{LINK} to generate switch control signal CS₁. In at least one embodiment, controller 504 generates switch control signal CS₁ in the same manner as controller 302 generates control signal CS₀. Controller 504 monitors the rectified input voltage V_{Φ}_{_{—}}_{RECT} and the link voltage V_{LINK}. Controller 504 generates control signal CS₁ to control conductivity of switch 506 in order to provide power factor correction and regulate link voltage V_{LINK}. During PFC mode, controller 504 provides power factor correction for switching power converter 502 after any phase delay α of input voltage V_{Φ}_{_{—}}_{RECT}. (A phase delay α of 0 indicates an absence of dimming). Control of power factor correction and the output voltage V_{OUT} of switching power converter 102 is, for example, described in the exemplary embodiments of Melanson I, II, III, IV, V, and VI.

In at least one embodiment, controller 504 has two modes of controlling switching power converter 502, PFC mode and maintenance mode. Controller 502 operates in PFC mode during each cycle of rectified input voltage V_{Φ}_{_{—}}_{RECT} to provide power factor correction as previously described. During any phase delay α of input voltage V_{Φ}_{_{—}}_{RECT}, controller 504 operates in maintenance mode.

When supplying a reactive load, such as switching power converter 502, the phase control dimmer 305 can miss generating phase delays a in some cycles of phase modulated signal V_{Φ}_{_{—}}_{DIM} and can generate ripple during the phase delays α. Missing phase delays α and ripple during phase delays a can cause errors in determining the value of duty cycle signal DCYCLE. During maintenance mode, controller 504 causes switching power converter 502 to have an input resistance that allows phase control dimmer 305 to generate rectified input voltage V_{Φ}_{_{—}}_{RECT} with a substantially uninterrupted phase delay α during each half-cycle of the input voltage V_{Φ}_{_{—}}_{RECT} during the dimming period. In at least one embodiment, controller 504 establishes an input resistance of switching power converter 502 during the maintenance mode that allows phase control dimmer 305 to phase modulate the supply voltage V_{IN} so that rectified input voltage V_{Φ}_{_{—}}_{RECT} has a single, uninterrupted phase delay during each half cycle of the input voltage V_{Φ}_{_{—}}_{RECT}. A complete discussion of exemplary operation of controller 504 in PFC mode and maintenance mode is described in Melanson VI.

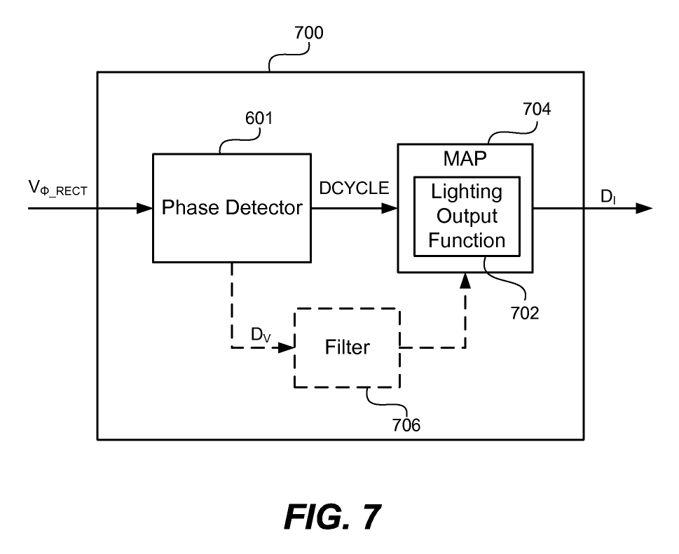

FIG. 7 depicts converter 700, which represents another embodiment of converter 505. Converter 700 includes phase detector 601 to generate dimmer output duty cycle signal DCYCLE. A mapping module 704 includes a lighting output function 702 to map rectified phase control input voltage V_{Φ}_{_{—}}_{RECT} to dimmer information D_{I}.

The particular mapping of lighting output function 702 is a matter of design choice, which provides flexibility to converter 700 to map the light intensity level indicated by the conduction angle of rectified phase control input voltage V_{Φ}_{_{—}}_{RECT} to any light intensity level. For example, in at least one embodiment, the lighting output function 704 maps values of the duty cycle signal DCYCLE to a human perceived lighting output levels with, for example, an approximately linear relationship. The lighting output function 702 can also map values of the duty cycle signal DCYCLE to other lighting functions. For example, the lighting output function 702 can map a particular duty cycle signal DCYCLE to a timing signal that turns lamp 312 (FIG. 3) “off” after a predetermined amount of time if the duty cycle signal DCYCLE does not change during a predetermined amount of time.

The lighting output function 702 can map dimming levels represented by values of a dimmer output signal to a virtually unlimited number of functions. For example, lighting output function 702 can map a low percentage dimming level, e.g. 90% dimming, to a light source flickering function that causes the lamp 312 to randomly vary in intensity for a predetermined dimming range input. In at least one embodiment, the intensity of lamp 312 results in a color temperature of no more than 2500 K. Controller 504 can cause lamp 312 to flicker by generating dimming information D_{I} to provide random dimming information to lamp ballast 310.

In one embodiment, conduction angles of rectified phase control input voltage V_{Φ}_{_{—}}_{RECT} represent duty cycles of rectified phase control input voltage V_{Φ}_{_{—}}_{RECT} corresponding to an intensity range of lamp 312 of approximately 95% to 10%. The lighting output function maps the conduction angles of rectified phase control input voltage V_{Φ}_{_{—}}_{RECT} to provide an intensity range of the lamp 312 of greater than 95% to less than 5%.

The implementation of mapping module 704 and the lighting output function 702 are a matter of design choice. For example, the lighting output function 702 can be predetermined and embodied in a memory. The memory can store the lighting output function 702 in a lookup table. For each dimmer output signal value of duty cycle signal DCYCLE, the lookup table can include one or more corresponding dimming values represented by dimming information D_{I}. In at least one embodiment, the lighting output function 702 is implemented as an analog function generator that correlates conduction angles of rectified phase control input voltage V_{Φ}_{_{—}}_{RECT} to dimming values represented by dimming information D_{I}.

FIG. 8 depicts a graphical depiction 800 of an exemplary lighting output function 702. Conventionally, as measured light percentage changes from 10% to 0%, human perceived light changes from about 32% to 0%. The exemplary lighting output function 702 maps the light intensity percentage as specificed by the duty cycle signal DCYCLE to dimming information D_{I} that provides a linear relationship between perceived light percentages and dimming level percentages. Thus, when the conduction angle of rectified phase control input voltage V_{Φ}_{_{—}}_{RECT} indicates a dimming level of 50%, the perceived light percentage is also 50%, and so on. By providing a linear relationship, the exemplary lighting output function 702 provides the phase control dimmer 305 with greater sensitivity at high dimming level percentages.

FIG. 9 depicts a graphical representation 900 of an exemplary lighting output function in-rush current protection module 702, which represents an estimation of normal operation of phase control dimmer 305 that protects lamp 312 (FIG. 3) from oscillations of rectified phase control input voltage V_{Φ}_{_{—}}_{RECT} at low conduction angles and potential errors in high conduction angles. Phase control dimmer 305 maps conduction angles of rectified phase control input voltage V_{Φ}_{_{—}}_{RECT} to a light intensity level ranging from about 8% to 100%. For conduction angles ranging from 0 to a minimum conduction angle threshold CA-TH_{MIN} of, for example, about 0°, mapping function 702 maps dimming information D_{I} equal to 0V. Mapping conduction angles of 0-15° prevents random oscillations of lamp 312 that could occur as a result of inaccuracies in phase control dimmer 305. For conduction angles of rectified phase control input voltage V_{Φ}_{_{—}}_{RECT} between about 15° and 30°, lighting output function 702 maps rectified phase control input voltage V_{Φ}_{_{—}}_{RECT} to dimming information D_{I} equal to 1V. For conduction angles of rectified phase control input voltage V_{Φ}_{_{—}}_{RECT} between 30° and to a maximum conduction angle threshold CA-TH_{MAX} of 170°, lighting output function 702 linearly maps the conduction angles to values of dimming information D_{I} ranging from 1V and 10V.

Referring to FIG. 7, a signal processing function can be applied in converter 700 to alter transition timing from a first light intensity level to a second light intensity level. The function can be applied before or after mapping with the lighting output function 702. In at least one embodiment, the signal processing function is embodied in a filter 706. When using filter 706, filter 706 processes the duty cycle signal DCYCLE prior to passing the filtered duty cycle signal DCYCLE to mapping module 704. The conduction angles of rectified phase control input voltage V_{Φ}_{_{—}}_{RECT} can change abruptly, for example, when a switch on phase control dimmer 305 is quickly transitioned from 90% dimming level to 0% dimming level. Additionally, rectified phase control input voltage V_{Φ}_{_{—}}_{RECT} can contain unwanted perturbations caused by, for example, fluctuations in line voltage V_{IN}.

Filter 706 can represent any function that changes the dimming levels specified by the duty cycle signal DCYCLE. For example, in at least one embodiment, filter 706 filters the duty cycle signal DCYCLE with a low pass averaging function to obtain a smooth dimming transition. In at least one embodiment, abrupt changes from high dimming levels to low dimming levels are desirable. Filter 706 can also be configured to smoothly transition low to high dimming levels while allowing an abrupt or much faster transition from high to low dimming levels. Filter 706 can be implemented with analog or digital components. In another embodiment, the filter filters the dimming information D_{I} to obtain the same results.

Thus, in at least one embodiment, a power control/lighting system includes a controller to provide compatibility between a lamp ballast configured to receive a dedicated dimmers signal and a phase control dimmer.

Although the present invention has been described in detail, it should be understood that various changes, substitutions and alterations can be made hereto without departing from the spirit and scope of the invention as defined by the appended claims.

What is claimed is:

1. An apparatus comprising:
a controller having an input to receive a phase control dimming signal, wherein the controller is configured to: (i) convert the phase control dimming signal into dimming information and (ii) generate a power factor correction (PFC) control signal for a switching power converter, wherein the controller further includes a first output to provide the dimming information and a second output to provide the PFC control signal.

2. The apparatus of claim 1 wherein the controller comprises an integrated circuit and the input, first output, and second output comprise pins of the integrated circuit.

3. The apparatus of claim 1 wherein the dimming information is a member of a group consisting of: a pulse width modulated signal, a linear voltage signal, a nonlinear voltage signal, a digital addressable lighting interface protocol signal, and an inter-integrated circuit (I²C) protocol signal.

4. The apparatus of claim 1 wherein the phase control dimming signal has a conduction angle generated by a member of a group consisting of: a bidirectional triode thyristor (triac)-based circuit and a transistor based circuit.

5. The apparatus of claim 1 wherein to convert the phase control dimming signal into dimming information, the controller is further configured to:
detect a duty cycle of the phase control dimming signal;
generate a dimming signal value indicating the duty cycle; and
convert the dimming signal value into the dimming information.

6. The apparatus of claim 1 wherein to convert the phase control dimming signal into dimming information, the controller is further configured to:
detect duty cycles of the phase control dimming signal;
convert the duty cycles of the phase control dimming signal into digital data representing the detected duty cycles, wherein the digital data correlates to light intensity levels; and
map the digital data to values of the control signal using a predetermined lighting output function.

7. The apparatus of claim 1 wherein the phase control dimming signal is a time varying voltage generated by a triac-based dimmer, the switching power converter includes a switch having a control terminal to receive the PFC control signal to control voltage conversion of the phase control dimming signal, and the controller is further configured to:
establish an input resistance of the switching power converter during a dimming portion of the phase control dimming signal, wherein the input resistance allows the triac-based dimmer to generate the phase control dimming signal with a substantially uninterrupted phase delay during each half-cycle of the phase control dimming signal during a dimming period.

8. The apparatus of claim 1 wherein to convert the phase control dimming signal into dimming information, the controller is further configured to:
map the phase control dimming signal to the dimming information using a predetermined lighting output function.

9. The apparatus of claim 8 wherein the predetermined lighting output function is configured to map the phase control dimming signal to a light intensity level different than a light intensity level indicated by a conduction angle of the phase control dimming signal.

10. The apparatus of claim 1 wherein the controller is configured to control a supply of power factor corrected power to a discharge-type lighting system and provide the dimming information for the discharge-type lighting system.

11. A method comprising:
receiving a phase control dimming signal;
converting the phase control dimming signal into dimming information for a lighting system; and
generating a power factor correction (PFC) control signal for a switching power converter.

12. The method of claim 11 wherein the dimming information is a member of a group consisting of: a pulse width modulated signal, a linear voltage signal, a nonlinear voltage signal, a digital addressable lighting interface protocol signal, and an inter-integrated circuit (I²C) protocol signal.

13. The method of claim 11 wherein the phase control dimming signal has a conduction angle generated by a member of a group consisting of: a bidirectional triode thyristor (triac)-based circuit and a transistor based circuit.

14. The method of claim 11 wherein converting the phase control dimming signal into dimming information for a lighting system comprises:
detecting a duty cycle of the phase control dimming signal;
generating a dimming signal value indicating the duty cycle; and
converting the dimming signal value into the dimming information.

15. The method of claim 11 wherein converting the phase control dimming signal into dimming information for a lighting system comprises:
detecting duty cycles of the phase control dimming signal;
converting the duty cycles of the phase control dimming signal into digital data representing the detected duty cycles, wherein the digital data correlates to light intensity levels; and
mapping the digital data to values of the control signal using a predetermined lighting output function.

16. The method of claim 11 wherein the phase control dimming signal is a time varying voltage generated by a triac-based dimmer, the method further comprises:
establish an input resistance of the switching power converter during a dimming portion of the phase control dimming signal, wherein the input resistance allows the triac-based dimmer to generate the phase control dimming signal with a substantially uninterrupted phase delay during each half-cycle of the phase control dimming signal during a dimming period.

17. The method of claim 11 wherein converting the phase control dimming signal into dimming information for a lighting system comprises:
mapping the phase control dimming signal to the dimming information using a predetermined lighting output function.

18. The method of claim 17 wherein mapping the phase control dimming signal to the dimming information using a predetermined lighting output function comprises mapping the phase control dimming signal to a light intensity level different than a light intensity level indicated by a conduction angle of the phase control dimming signal.

19. The method of claim 11 further comprising:
providing the PFC control signal to the switching power converter to control power factor correction and output voltage regulation of the switching power converter.

20. The method of claim 11 further comprising:
providing the dimming information to a lighting system.

21. The method of claim 20 wherein providing the dimming information to a lighting system comprises:
providing the dimming information to a discharge-type lighting system.

22. A power control/lighting system comprising:
a switching power converter having at least one input to receive a phase control dimming signal;
a controller having an input to receive the phase control dimming signal, wherein the controller is configured to: (i) convert the phase control dimming signal into dimming information and (ii) generate a power factor correction (PFC) control signal for a switching power converter, wherein the controller further includes a first output to provide the dimming information and a second output coupled to the switching power converter to provide the PFC control signal;
a lamp ballast coupled to the switching power converter and the second output of the controller; and
a discharge-type lamp coupled to the lamp ballast.

23. The power control/lighting system of claim 22 wherein the controller comprises an integrated circuit and the input, first output, and second output comprise pins of the integrated circuit.

24. The power control/lighting system of claim 22 wherein the dimming information is a member of a group consisting of: a pulse width modulated signal, a linear voltage signal, a nonlinear voltage signal, a digital addressable lighting interface protocol signal, and an inter-integrated circuit (I²C) protocol signal.

25. The power control/lighting system of claim 22 wherein the phase control dimming signal has a conduction angle generated by a member of a group consisting of: a bidirectional triode thyristor (triac)-based circuit and a transistor based circuit.

26. The power control/lighting system of claim 22 wherein to convert the phase control dimming signal into dimming information, the controller is further configured to:
detect a duty cycle of the phase control dimming signal;
generate a dimming signal value indicating the duty cycle; and
convert the dimming signal value into the dimming information.

27. The power control/lighting system of claim 22 wherein to convert the phase control dimming signal into dimming information, the controller is further configured to:
detect duty cycles of the phase control dimming signal;
convert the duty cycles of the phase control dimming signal into digital data representing the detected duty cycles, wherein the digital data correlates to light intensity levels; and
map the digital data to values of the control signal using a predetermined lighting output function.

28. The power control/lighting system of claim 22 wherein the phase control dimming signal is a time varying voltage generated by a triac-based dimmer, the switching power converter includes a switch having a control terminal to receive the PFC control signal to control voltage conversion of the phase control dimming signal, and the controller is further configured to:
establish an input resistance of the switching power converter during a dimming portion of the phase control dimming signal, wherein the input resistance allows the triac-based dimmer to generate the phase control dimming signal with a substantially uninterrupted phase delay during each half-cycle of the phase control dimming signal during a dimming period.

29. The power control/lighting system of claim 22 wherein to convert the phase control dimming signal into dimming information, the controller is further configured to:
map the phase control dimming signal to the dimming information using a predetermined lighting output function.

30. The power control/lighting system of claim 29 wherein the predetermined lighting output function is configured to map the phase control dimming signal to a light intensity level different than a light intensity level indicated by a conduction angle of the phase control dimming signal.
